(19) United States
(12) Patent Application Publication
(10) Pub. No.: US 2007/0162224 A1
(43) Pub. Date: Jul. 12, 2007

(54) Systems and method for providing a navigation route on a geographical map based on a road portion selected by a pointer placed thereon

(76) Inventor: Gang Luo, Fairfax Station, VA (US)

Correspondence Address: GANG LUO, 9070 EMMA ANN WAY, FAIRFAX STATION, VA, 22039, US

(21) Appl. No.: 11/330,105

(22) Filed: Jan. 12, 2006

(51) Int. Cl. G01C 21/00

(52) U.S. Cl. 701/210; 701/200; 701/211

(57) ABSTRACT

A navigation system includes a display that displays a geographic map, the geographical map including a plurality of road portions; a display detector that detects, when a pointer is placed on one of the plurality of road portions to select a specific road portion on the geographical map, a geographical location of the selected road portion; and a route finder that determines a route based on the geographical location of the selected road portion, the route connecting a starting geographical location and a destination geographical location via at least one of the plurality of road portions.

### BACKGROUND

U.S. Patent Publication No. US 2005/0102102 A1 to Linn (“Linn”), which is herein incorporated by reference in its entirety, discloses a method for navigation system that modifies a route to a destination determined by inputting the address of the destination. Linn allows a user to select a type of conditions to be omitted from the route. Linn's method include displaying a set of data indicative of conditions that will occur if the user follows a calculated route; prompting the user to select a type of conditions to be avoided in a new route; and recalculating the new route according to the user's selection.

In particular, Linn discloses a navigation system that includes a controller for processing traffic data. The traffic data is obtained from a traffic database via a radio communication device such as a satellite radio transmitter, FM sub-carrier transmitter, a cellular phone, or a Bluetooth transceiver. The traffic data is classified by the controller into condition types such as road construction, traffic incident, point of interest, and traffic maneuver. The traffic data is further classified by the controller based on the distance of a condition from the driver of a vehicle. The driver is allowed to view a list of condition types and to select a condition type from the list such that the conditions belonging to the selected condition type are omitted in the recalculated route.

### SUMMARY

However, Linn presents certain disadvantages. First, Linn's selection of condition type is via a condition list displayed on the navigation system. Thus, Linn requires the driver to view the list before a selection can be made. Such a process may impose inconvenience to the driver, because such a selection is indirect. In particular, the driver has to go through the extra step of viewing the list first. Such a process may also inconvenience the driver because the driver is required to look away from the direction in which the driver is driving a vehicle, and to focus on the list, which may raise a safety issue when the vehicle is in motion.

Secondly, Linn's system requires a special device to obtain traffic data and a special controller to process the traffic data. Such special device and special controller increase the cost of the navigation system. The increased cost may make the navigation system unavailable to a certain percentage of the population. In addition, the requirement of the special device and special controller, as well as the requirement of the traffic database, makes the navigation system more vulnerable to downtimes. For example, the driver may not be able to make a selection when one of the special device, the special controller, or the traffic database is malfunctioning, even if the navigation system is otherwise in good working condition.

Additionally, Linn only allows omission of a type of conditions. Linn does not enable omission of an individual condition. Such a restriction inconveniences a driver if the driver desires to omit one condition in a condition type, but not to omit another condition in the same condition type.

Furthermore, Linn allows only omission of conditions. Linn does not enable addition of conditions. Such a restriction inconveniences a driver if the driver desires to add a road or point of interest to a calculated route. For example, a reporter who is on a calculated route may decide to detour to a place of news value that is recently brought to his attention via radio or cellular phone. He may want to modify the calculated route so as to visit that place before continuing to the original destination of the calculated route. Also, a person who is on a calculated route may, after a conversation over the cellular phone, decide to detour to a school to pick up his daughter, to a bar to meet with a friend, or to a dry clean place to pick up his suits, before continuing to the destination of the calculated route. Linn does not enable modification of the calculated route to add the detours.

Finally, Linn's navigation system requires the street address of the destination be entered. Such a requirement may raise a safety issue if the driver desires to enter the street address while the vehicle is in motion. Also, such a requirement may impose inconveniences if the driver only knows the location of the destination on a map, but does not know the street address of the destination.

Systems and methods are provided in this disclosure that enable a user to modify a calculated route to avoid conditions without having to view a list of condition types.

Systems and methods are provided in this disclosure that enable a user to modify a calculated route to avoid conditions without having to use a special device or controller to obtain or process traffic data from a traffic database.

Systems and methods are provided in this disclosure that enable a user to modify a calculated route to avoid an individual condition, instead of having to avoid a type of conditions, in a new route.

Systems and methods are provided in this disclosure that enable a user to modify a calculated route to add detours in a new route.

Systems and methods are provided in this disclosure that enable a user to calculate a route by placing a pointer at a road portion in a displayed geographical map to select the road portion.

In various exemplary embodiments, a navigation system includes a display that displays a geographic map, the geographical map including a plurality of road portions; a display detector that detects, when a pointer is placed at one of the plurality of road portions to select a specific road portion in the geographical map, a geographical location of the selected road portion; and a route finder that determines a route based on the geographical location of the selected road portion, the route connecting a starting geographical location and a destination geographical location via at least one of the plurality of road portions.

In various exemplary embodiments, a method for providing a route on a navigation system includes displaying a geographic map on a display, the geographical map including a plurality of road portions; detecting, when a pointer is placed at one of the plurality of road portions to select a specific road portion in the geographical map, a geographical location of the selected road portion; and determining a route based on the geographical location of the selected road portion, the route connecting a starting geographical location and a destination geographical location via at least one of the plurality of road portions.

These and other features and details are described in, or are apparent from, the following detailed description.

### BRIEF DESCRIPTION OF THE DRAWINGS

Various exemplary details of systems and methods are described, with reference to the following figures, wherein:

FIG. 1 illustrates an exemplary navigation network having an exemplary navigation system;

FIG. 2 illustrates a first exemplary map display;

FIG. 3 illustrates a second exemplary map display;

FIG. 4 illustrates a third exemplary map display;

FIG. 5 illustrates a fourth exemplary map display;

FIG. 6 illustrates a fifth exemplary map display;

FIG. 7 illustrates a sixth exemplary map display;

FIG. 8 illustrates a seventh exemplary map display;

FIG. 9 illustrates an eighth exemplary map display;

FIG. 10 illustrates a ninth exemplary map display; and

FIG. 11 illustrates an exemplary method for providing a route.

### DETAILED DESCRIPTION OF EMBODIMENTS

Various embodiments provide a navigation route on a geographical map based on a road portion selected by a pointer placed at the road portion in the map. The embodiments provide various improvements over Linn.

Linn discloses a method for navigation system that modifies a route to a destination determined by inputting the address of the destination. The method allows a user to select a type of conditions to be omitted from the route, including displaying a set of data indicative of conditions that will occur if the user follows a calculated route, prompting the user to select a type of conditions to be avoided in a new route, and recalculating the new route according to the user's selection. Linn discloses a navigation system that includes a controller for processing traffic data. The traffic data is obtained from a traffic database via a radio communication device such as a satellite radio transmitter, FM sub-carrier transmitter, a cellular phone, or a Bluetooth transceiver. The traffic data is classified by the controller into condition types such as road construction, traffic incident, point of interest, and traffic maneuver. The traffic data is further classified by the controller based on the distance of a condition from the driver of a vehicle. The driver is allowed to view a list of condition types and to select a condition type from the list such that the conditions belonging to the selected condition type are omitted in the recalculated route. A detailed description of Linn's method and system is provided in U.S. Patent Publication No. US 2005/0102102 A1 to Linn, which is herein incorporated by reference in its entirety.

Various improvements over Linn are provided in view of various disadvantages in Linn's method and system. For example, Linn's selection of condition type is via a condition list displayed on the navigation system. Thus, Linn requires the driver to view the list before a selection can be made. Such a process may impose inconvenience to the driver, because such a selection is indirect. In particular, the driver has to go through the extra step of viewing the list first. Such a process may also inconvenience the driver because the driver is required to look away from the direction in which the driver is driving a vehicle, and to focus on the list, which may raise a safety issue when the vehicle is in motion. Accordingly, in one aspect of the improvements, systems and methods are provided in this disclosure that enable a user to modify a calculated route to avoid conditions without having to view a list of condition types.

Also, Linn's system requires a special device to obtain traffic data and a special controller to process the traffic data. Such special device and special controller increase the cost of the navigation system. The increased cost may make the navigation system unavailable to a certain percentage of the population. In addition, the requirement of the special device and special controller, as well as the requirement of the traffic database, makes the navigation system more vulnerable to downtimes. For example, the driver may not be able to make a selection when one of the special device, the special controller, or the traffic database is malfunctioning, even if the navigation system is otherwise in good working condition. Accordingly, in a second aspect of the improvements, systems and methods are provided in this disclosure that enable a user to modify a calculated route to avoid traffic conditions without having to use a special device or controller to obtain or process traffic data from a traffic database.

Additionally, Linn only allows omission of a type of conditions. Linn does not enable omission of an individual condition. Such a restriction inconveniences a driver if the driver desires to omit one condition in a condition type, but not to omit another condition in the same condition type. Accordingly, in a third aspect of the improvements, systems and methods are provided in this disclosure that enable a user to modify a calculated route to avoid an individual condition, instead of having to avoid a type of conditions, in a new route.

Furthermore, Linn allows only omission of conditions. Linn does not enable addition of conditions. Such a restriction inconveniences a driver if the driver desires to add a road or point of interest to a calculated route. For example, a reporter who is on a calculated route may decide to detour to a place of news value that is recently brought to his attention via radio or cellular phone. He may want to modify the calculated route so as to visit that place before continuing to the original destination of the calculated route. Also, a person who is on a calculated route may, after a conversation over the cellular phone, decide to detour to a school to pick up his daughter, to a bar to meet with a friend, or to a dry clean place to pick up his suits, before continuing to the destination of the calculated route. Linn does not enable modification of the calculated route to add the detours. Accordingly, in a fourth aspect of the improvements, systems and methods are provided in this disclosure that enable a user to modify a calculated route to add detours in a new route.

In addition, Linn's navigation system requires the street address of the destination be entered. Such a requirement may raise a safety issue if the driver desires to enter the street address while the vehicle is in motion. Also, such a requirement may impose inconveniences if the driver only knows the location of the destination on a map, but does not know the street address of the destination. Accordingly, in a fifth aspect of the improvements, systems and methods are provided in this disclosure that enable a user to calculate a route by placing a pointer at a road portion in a displayed geographical map to select the road portion.

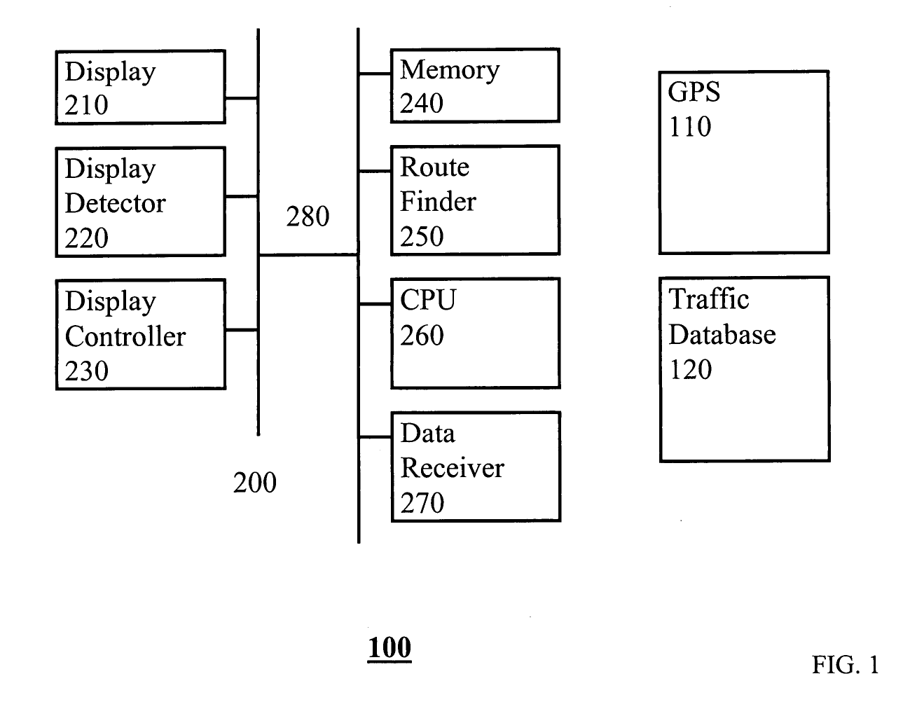

FIG. 1 illustrates an exemplary navigation network having an exemplary navigation system. As shown in FIG. 1, the navigation network 100 includes a navigation system 200 that may communicate, if needed, with a global positioning system (GPS system) 110 and a traffic database 120.

The navigation system 200 may include a display 210, a display detector 220, a display controller 230, a memory 240, a route finder 250, a central processing unit (CPU) 260, and a data receiver 270, each being interconnected via a connection 280. The connection 280 may be a data bus. The connection 280 may also be a wired or wireless connection, such as, for example, an intranet or the Internet. For example, the memory 240, the route finder 250, the central processing unit (CPU) 260, and the data receiver 270 may be connected by wired connection and reside at a main office, while the display 210, the display detector 220, and the display controller 230 may be remotely connected to the main office via the Internet.

In the navigation system 200 shown in FIG. 1, the CPU 260 may send commands to, and control the operation of, one or more of the display 210, the display detector 220, the display controller 230, the route finder 250, and the data receiver 270. The memory 240 may store map information, geographical data of points of interest (POIs), information received from GPS system 110, and traffic data received from traffic database 120. The memory 240 may also store previously and newly calculated navigation routes, route starting point and destination information received from a user via entry of a street address or via placement of a pointer at a street portion in a displayed geographical map, and route modification information from a user. The memory 240 may be accessed by one or more of the CPU 260, the display 210, the display detector 220, the display controller 230, the route finder 250, and the data receiver 270.

The display 210 may display a geographical map based on map information. The geographical map may include a plurality of roads or streets, as well as portions and intersections of roads and streets. The display may also display POIs based on point of interest information, road condition information based on traffic data received from traffic database 120, and various instructions and options for a user to view and to select. In addition, the display 120 may display navigation routes and/or portions thereof. The navigation routes include routes determined from start points and/or destinations provided by a user. The navigation routes may also include previously calculated routes and/or newly determined routes that modify the previously calculated routes.

The display detector 220 may detect the location of a pointer on the display 210. The pointer may be used by a user to select a road portion or a geographical location in the displayed map. The pointer may be the cursor of a mouse, a joystick, or the like. The pointer may also be a user's finger, a pen, or the like, that touches or presses the display 210 via a screen, a panel, or the like, of the display 210. The detected location may be registered as an X-Y coordinate value that describes the two dimensional space on the display 210. The detected location may also registered according to other technologies that obtain information from, for example, a touch on a display screen or a cursor on a monitor screen. For example, the detection of the location, and the registration of the detected location, may be obtained by the technologies used in Linn to receive a selection from a user via the user's manipulation of options displayed on a monitor. The display detector 220 may match the detected location with a geographical location based on the map information.

The display controller 230 may control the operation of display 210. For example, the display controller 230 may synthesize the geographical information of a route with the geographical map, and control the superimposition of the route, or a part of the route, on the displayed portion of the geographical map. The display controller 230 may also synthesize the geographical information of traffic data received from traffic database 120 with the geographical map, and control the superimposition of traffic data received from traffic database 120, if necessary, on the displayed portion of the geographical map. In addition, the display controller 230 may control the zoom-in/zoom-out of the map, the portion of the map that is to be displayed, and the shift (scrolling up/down, left/right, and combinations thereof) of the displayed portion of the map.

The route finder 250 may determine a navigation route that may be displayed on display 210. The route finder 250 may determine the route based on a destination and a starting point of the route. The destination may be provided by a user using a street address of the destination or a pointer placed at the destination location in the displayed map. The starting point may be provided by the user using a street address of the starting point, a pointer placed at the starting point location in the displayed map, or the GPS system 110 that determines the location of the user. For example, when the destination is provided by a first touch of the user's finger at a first location in the map, the starting point may be provided by the location of the user detected by the GPS system 110, or by a second touch of the user's finger at a second location in the map. In another example, when the starting point is provided by a first touch of the user's finger at a first point in the map, the destination may be provided by a second touch of the user's finger at a second point in the map. The location or point in the map that is touched by the user's finger may include a road portion. The road portion may include a road or street, a portion of a road or street, an intersection of roads or streets, and the like.

The route finder 250 may also determine a new route that modifies a previous route already displayed on display 210 to avoid a road portion. The route finder 250 may determine the modification based a selection of the user by placing a pointer at a road portion in the map. For example, when a user wishes to modify a pre-calculated route to avoid a specific road portion, the user may touch the specific road portion in the map so as to select the specific road portion. The touch may be detected by the display detector 220 to be matched with a geographical location. Based on the detected geographical location and the pre-calculated route, the route finder 250 may determine a new route that omits the specific road portion and includes a new road portion. The new road portion replaces the omitted specific road portion such that the new route is a complete route between the same starting point and the destination that were originally connected via the omitted specific road portion.

In various embodiments, the amount of modification is limited such that the new route is substantially identical to the pre-calculated route except for the difference associated with the specific road portion. The difference includes that the specific road portion was included in the pre-calculated route but is excluded in the new route. The difference also includes the exclusion from the new route certain other road portions that were included in the pre-calculated route. Such certain other road portions are related to the omitted specific road portion, such that, based on the route-determining process of the navigation system 200, those other road portions should also be omitted.

In addition, the difference also includes the inclusion in the new route additional road portions that were not included in the pre-calculated route. Such additional road portions are related to the new road portion, such that, based on the route-determining process of the navigation system 200, those additional road portions should also be added, in place of the omitted certain other road portions, so as to make the new route a complete route between the same starting point and the destination that were originally connected via the omitted specific road portion and the omitted certain other road portions.

Furthermore, the route finder 250 may also determine a new route that modifies a previous route already displayed on display 210 to add a road portion. The route finder 250 may determine the modification based a selection of the user by placing a pointer at a road portion in the map. For example, when a user wishes to modify a pre-calculated route to add a specific road portion, the user could touch the specific road portion in the map so as to select the specific road portion. The touch may be detected by the display detector 220 to be matched with a geographical location. Based on the detected geographical location and the pre-calculated route, the route finder 250 may determine a new route that adds the specific road portion and omits an old road portion. The added specific road portion replaces the omitted old road portion such that the new route is a complete route between the same starting point and the destination that were originally connected via the omitted old road portion.

In various embodiments, the amount of the modification is limited such that the new route is substantially identical to the pre-calculated route except for the difference associated with the specific road portion. The difference includes that the specific road portion was not included in the pre-calculated route but is included in the new route. The difference also includes the inclusion in the new route additional road portions that were not included in the pre-calculated route. Such additional road portions are related to the added specific road, such that, based on the route-determining process of the navigation system 200, those additional road portions should also be added.

In addition, the difference also includes the exclusion from the new route certain other road portions that were included in the pre-calculated route. Such certain other road portions are related to the omitted old road, such that, based on the route-determining process of the navigation system 200, those other road portions should also be omitted.

The data receiver 270 may receive from the GPS system 110 information for determining the geographical location of a user or the navigation system 200. The data receiver 270 may also receive traffic data from traffic databased 120. The communication with the traffic database 120 may be via a radio communication device such as a satellite radio transmitter, FM sub-carrier transmitter, a cellular phone, or a Bluetooth transceiver. A detailed description of such a communication is provided in Linn. It is appreciated that the communication with the traffic database 120 is necessary if traffic data from the traffic database 120 is used. When the traffic data from the traffic database 120 is not used, the communication with the traffic database 120 may be omitted, and, accordingly, the navigation system 200's capability to communicate with the traffic database is not required.

The navigation system 200 in FIG. 1 may be installed in a vehicle, and a user of the navigation system 200 may be a driver in the vehicle. The user may also be an assistant to the driver, such as a passenger of the vehicle. The user may also be an information provider that provides traffic information to others, such as drivers of vehicles.

The navigation system 200 in FIG. 1 may also be installed in a computerized device. The computerized device may be a portable or hand-held navigation system. The computerized device may also be a desktop computer, a portable computer such as a laptop computer, or a personal digital assistant (PDA). For example, when the computerized device is a desktop computer, the display 210 may be the monitor of the computer. The capabilities of the navigation system 200 may be implemented in the computer, in replacement of and/or in addition to existing on-line map-obtaining capabilities associated with Yahoo®, Mapquest®, or Google®, for a user to enhance the ability to obtain maps. In this regard, the navigation system may include wireless connections to connect data processing units and data storage units at a server site with display units at a client terminal. For example, the memory 240, the route finder 250, the central processing unit (CPU) 260, and the data receiver 270 may reside at the server, while the display 210, the display detector 220, and the display controller 230 may reside at a client terminal for a user to be remotely connected to the server via wireless connections, such as the Internet.

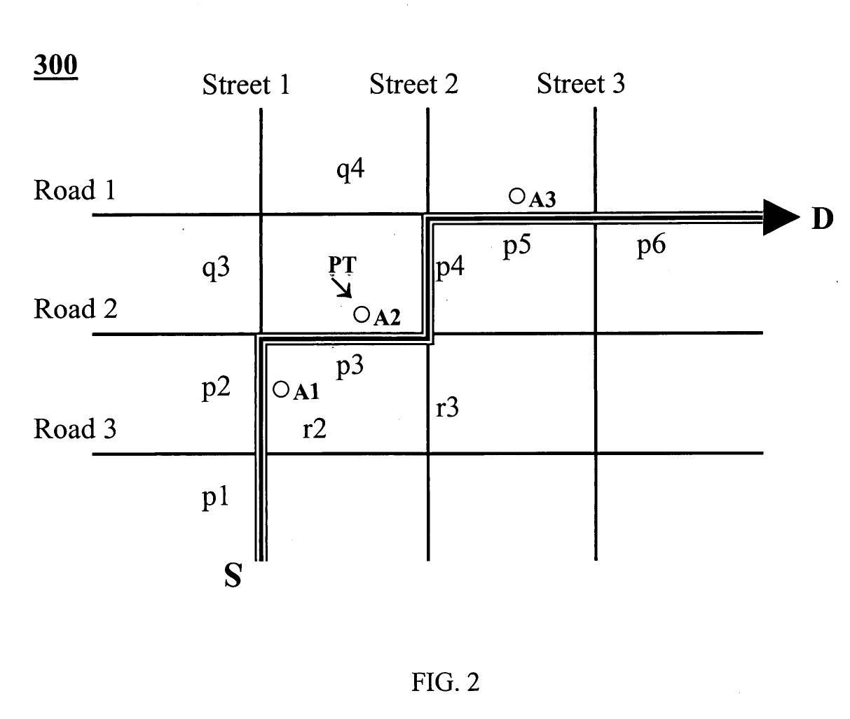

FIG. 2 illustrates a first exemplary map display. As shown in FIG. 2, a portion of a geographical map 300 is displayed, on the display 210 of the navigation system 200 of FIG. 1. The map 300 may include a plurality of roads, such as road 1, road 2, and road 3, and a plurality of streets, such as street 1, street 2, and street 3. The roads and streets may include road portions. The roads, streets, and road portions are each associated with geographical locations in the map. As shown in FIG. 2, road 1 includes road portions q4, p5 and p6. Road 2 includes road portion p3. Road 3 includes road portion r2. Street 1 includes road portions p1, p2, and q3. Street 2 includes road portions p4 and r3.

In a case when a user wishes to modify a pre-calculated route and when traffic data is received from the traffic database 120 of FIG. 1, the map display may superimpose the calculated route on the map for modification. The map display may also superimpose the traffic data on the map along with the calculated route. As shown in FIG. 2, in such a case, a pre-calculated route Rt1 connects starting point S and destination D and includes road portions p1, p2, p3, p4, p5 and p6 therebetween. The starting point S and the destination may be a starting geographical location and a destination geographical location, respectively, of the route. The calculated Rt1 may be previously determined based on input from a user. The input may include a location of the starting point and/or destination provided by placing a pointer in the map and/or by entering a street address.

In FIG. 2, road conditions A1, A2, and A3 are also shown along route Rt1. A road condition may indicate a location of an incident, a traffic jam, a construction, a type of traffic maneuver, a point of interest, or the like, based on the traffic data received from the traffic database. The road conditions A1, A2, and A3 indicate that a user who follows the calculated route Rt1 will encounter road conditions A1, A2, and A3.

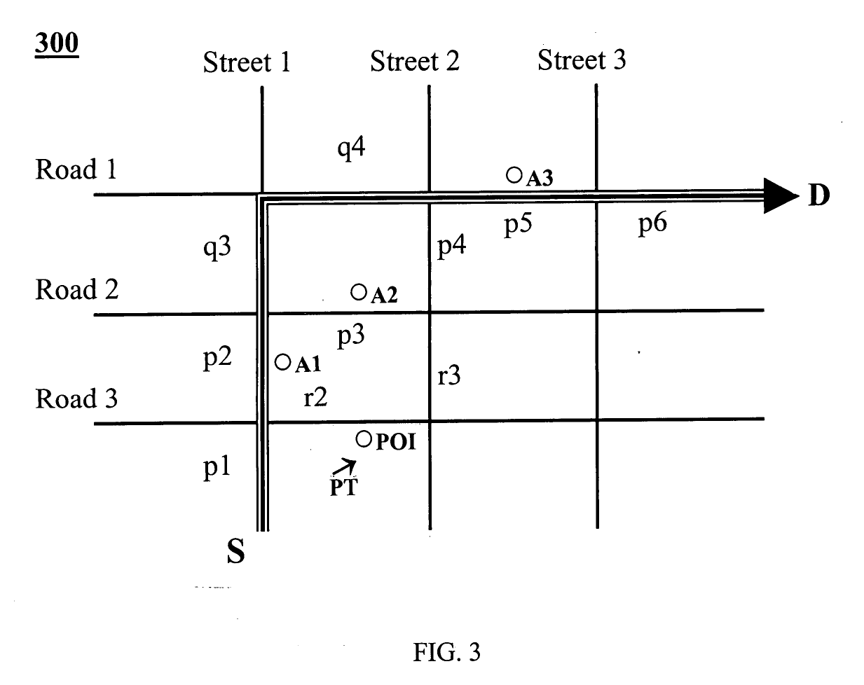

The user may wish to avoid a specific road portion associated with a specific road condition, while willing to follow other road portions of the calculated route Rt1. For example, while the user is not bothered by road conditions A1 and A3, the user may wish to modify the calculated route Rt1 into a new route that omits road portion p3 that is associated with road condition A2. The navigation system allows such an omission by prompting the user to place a pointer PT at the specific road portion p3 in the map to select road portion p3. For example, the navigation system prompts the user to select the specific road portion p3 in the map 300 by using a finger to touch the display at the specific road portion p3. The navigation system, using its various components as discussed above in connection with FIG. 1, will detect the touch, identify the location of the road portion p3, and determine a new route that excludes road portion p3, as shown in FIG. 3.

FIG. 3 illustrates a second exemplary map display. The map display in FIG. 3 is similar to that in FIG. 2. However, in FIG. 3, a second route Rt2 is displayed in place of the pre-calculated route Rt1. Although not shown in FIG. 3, the second route Rt2 may also be displayed in addition to the pre-calculated route Rt1. The second route Rt2 is the new route, as discussed above, that is determined to omit road portion p3, based on the user's selection of road portion p3. As shown in FIG. 3, the second route Rt2 includes road portions p1, p2, p5 and p6 that were originally included in the pre-calculated route Rt1 in FIG. 2. However, the second route Rt2 includes road portions q3 and q4 that were not included in Rt1, and excludes road portions p3 and p4 that were included in Rt1.

Although only road portion p3 was intended to be avoided, the second route Rt2 also excludes road portion p4. This is because, when omitting road portion p3, the road portion p4, that is related to the omission of road portion p3, has to be simultaneously omitted, so that new road portions q3 and a4 could be added to complete the second Rt2 between the starting point S and the destination D. Thus, the difference between Rt2 and Rt1 includes both the direct difference caused by the omission of road portion p3, and the related difference caused by the omission of road portion p4.

In FIG. 3, only road portions p3 and p4 are omitted in Rt2. Rt2 is otherwise identical to Rt1. Thus, the degree of modification is limited.

If the user is not satisfied with Rt2, the user may wish to further modify Rt2 into yet another new route that includes another road portion. For example, the user may wish to pass by a point of interest on road portion r2 before reaching the destination D. For example, after a conversation over the cellular phone, the user may decide to detour to a school to pick up his daughter, to a bar to meet with a friend, or to a dry clean place to pick up his suits, before continuing to the destination D. However, the street address of the point of interest on road portion r2 may not be available to the user, although the user knows the whereabouts of the point of interest on the map. Thus, the user may not be able to enter the street address of the point of interest into the navigation system.

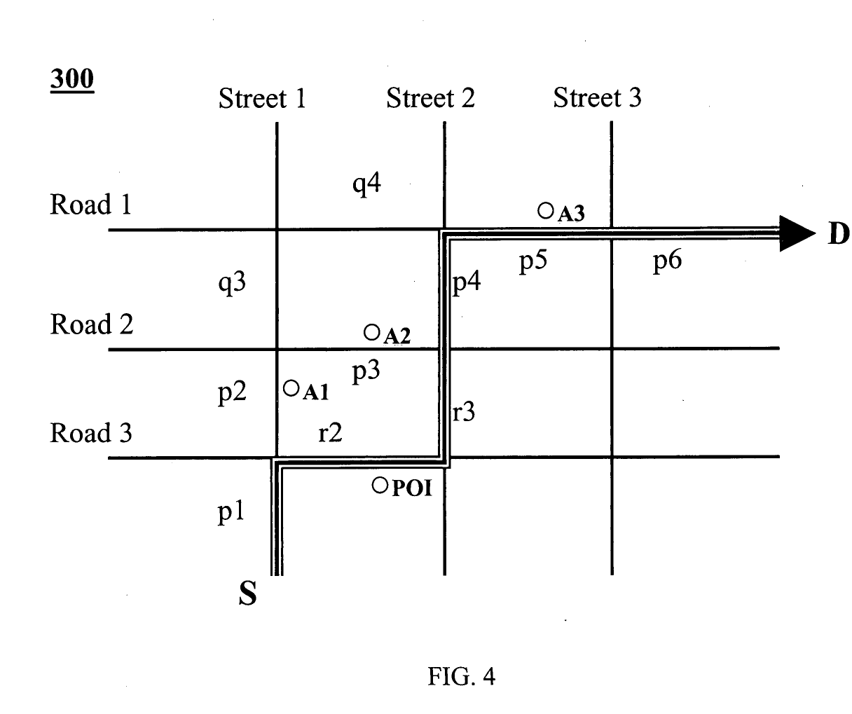

The navigation system allows an addition of road portion r2 by allowing or prompting the user to place a pointer PT at road portion r2 in the map to select road portion r2. For example, the navigation system allows or prompts the user to select road portion r2 in the map 300 by using a finger to touch the display at road portion r2. The navigation system, using its various components as discussed above in connection with FIG. 1, will detect the touch, identify the location of the road portion r2, and determine yet another new route that includes road portion r2, as shown in FIG. 4.

FIG. 4 illustrates a third exemplary map display. The map display in FIG. 4 is similar to that in FIG. 3. However, in FIG. 4, a third route Rt3 is displayed in place of the second route Rt2. Although not shown in FIG. 4, the third route Rt3 may also be displayed in addition to route Rt2. The third route Rt3 is the newest route that is determined to add road portion r2, based on the user's selection of road portion r2. As shown in FIG. 4, the third route Rt3 includes road portions p1, p5 and p6 that were included in the second route Rt2 in FIG. 3. However, the third route Rt3 includes road portions r2, r3 and p4 that were not included in Rt2, and excludes road portions p2, q3 and q4 that were included in Rt2.

Although only road portion r2 was intended to be added, the third route Rt3 also adds road portions r3 and p4. This is because, when adding road portion r2, the road portions r3 and p4, that are related to the addition of road portion r2, have to be simultaneously added to complete the third Rt3 between the starting point S and the destination D. Thus, the difference between Rt3 and Rt2 includes both the direct difference caused by the addition of road portion r2, and the related difference caused by the addition of road portions r3 and p4.

In FIG. 4, only road portions r2, r3 and p4 are added in Rt3. Rt3 is otherwise identical to Rt2. Although the degree of modification may appear large relative to the number of road portions displayed in FIG. 4, such a degree may actually be insignificant, because a route generally includes much more road portions. Thus, a new route will generally be substantially identical to an old route, and the degree of modification is generally limited.

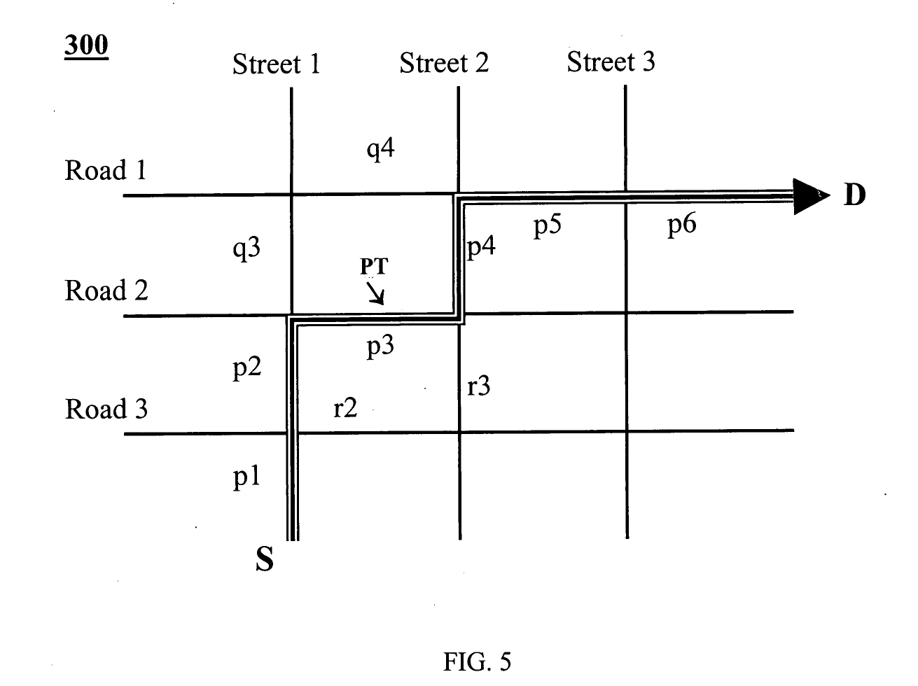

In various embodiments, traffic data from the traffic database 120 in FIG. 1 is not available or not needed for modifying a calculated route. FIG. 5 illustrates a fourth exemplary map display. The map display shown in FIG. 5 is similar to that shown in FIG. 2. In particular, as shown in FIG. 5, a portion of a geographic map 300 is displayed, and may include a plurality of roads, streets and road portions.

The map display may superimpose a calculated route Rt4 that is similar to Rt1 of FIG. 2. In particular, the pre-calculated route Rt4 connects starting point S and destination D and includes road portions p1, p2, p3, p4, p5 and p6 therebetween. The calculated Rt4 may be previously determined based on input from a user. The input may include a location of the starting point and/or destination provided by placing a pointer in the map and/or by entering a street address.

However, unlike Rt1 of FIG. 2, Rt4 of FIG. 5 does not have, or does not need, traffic data superimposed on the map display.

The user may wish to avoid a specific road portion, while willing to follow other road portions of the calculated route Rt1. For example, while the user does not mind going through road portions p1, p2, p4, p5 and p6, the user may wish to modify the calculated route Rt4 into a new route that omits road portion p3.

The user may wish to avoid road portion p3 for a variety of reasons. For example, the user may have just become aware that road portion 3 is jammed, from a piece of news on the radio, from a conversation over cellular phone with his wife, or simply from a pedestrian at a traffic light. Alternatively, the user may have read from a newspaper that road portion 3 will be under construction for a period of time. Still alternatively, the user may have personal experience that road portion 3 is always jammed at certain times of the day. Also, the user may simply does not like road portion 3.

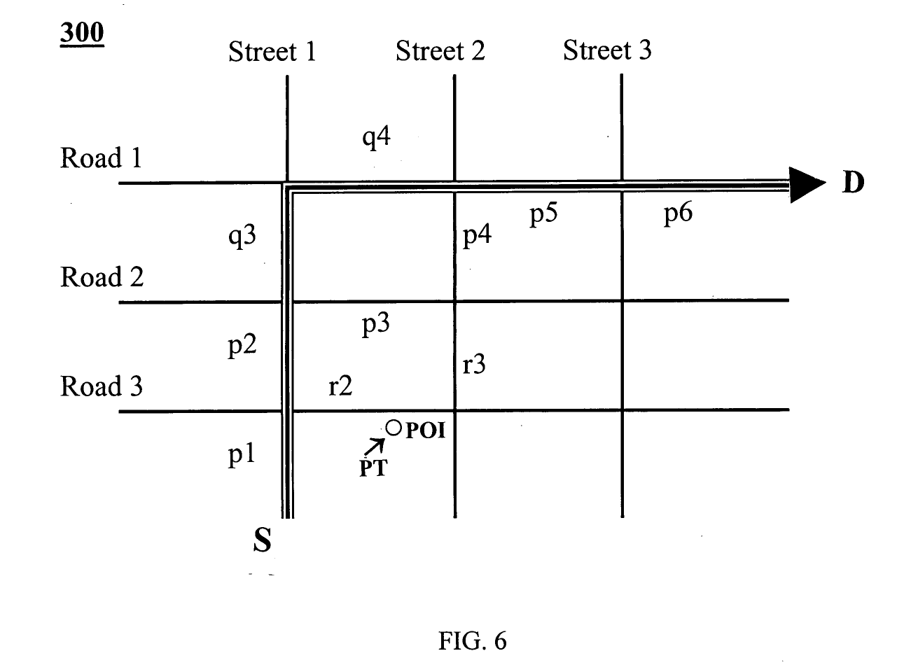

The navigation system allows the omission of road portion p3 by allowing or prompting the user to place a pointer PT at road portion p3 in the map to select road portion p3. For example, the navigation system allows or prompts the user to select road portion p3 in the map 300 by using a finger to touch the display at road portion p3. The navigation system, using its various components as discussed above in connection with FIG. 1, will detect the touch, identify the location of road portion p3, and determine a new route that excludes road portion p3, as shown in FIG. 6.

FIG. 6 illustrates a fifth exemplary map display. The map display in FIG. 6 is similar to that in FIG. 5. However, in FIG. 6, route Rt5 is displayed in place of the pre-calculated route Rt4. Although not shown in FIG. 6, route Rt5 may also be displayed in addition to route Rt4. Route Rt5 is the new route, as discussed above, that is determined to omit road portion p3, based on the user's selection of road portion p3. As shown in FIG. 6, route Rt5 includes road portions p1, p2, p5 and p6 that were originally included in the pre-calculated route Rt4 in FIG. 5. However, route Rt5 includes road portions q3 and q4 that were not included in Rt4, and excludes road portions p3 and p4 that were included in Rt4.

Although only road portion p3 was intended to be avoided, Rt5 also excludes road portion p4. This is because, when omitting road portion p3, road portion p4, that is related to the omission of road portion p3, has to be simultaneously omitted, so that new road portions q3 and a4 could be added to complete Rt5 between the starting point S and the destination D. Thus, the difference between Rt5 and Rt4 includes both the direct difference caused by the omission of road portion p3, and the related difference caused by the omission of road portion p4. However, in FIG. 3, only road portions p3 and p4 are omitted in Rt5. Rt5 is otherwise identical to Rt4. Thus, the degree of modification is limited.

If the user is not satisfied with Rt5, the user may wish to further modify Rt5 into yet another new route that includes another road portion. For example, the user may wish to pass by a point of interest on road portion r2 before reaching the destination D. For example, after a conversation over the cellular phone, the user may decide to detour to a school to pick up his daughter, to a bar to meet with a friend, or to a dry clean place to pick up his suits, before continuing to the destination D. However, the street address of the point of interest on road portion r2 may not be available to the user, although the user knows the whereabouts of the point of interest on the map. Thus, the user may not be able to enter the street address of the point of interest into the navigation system.

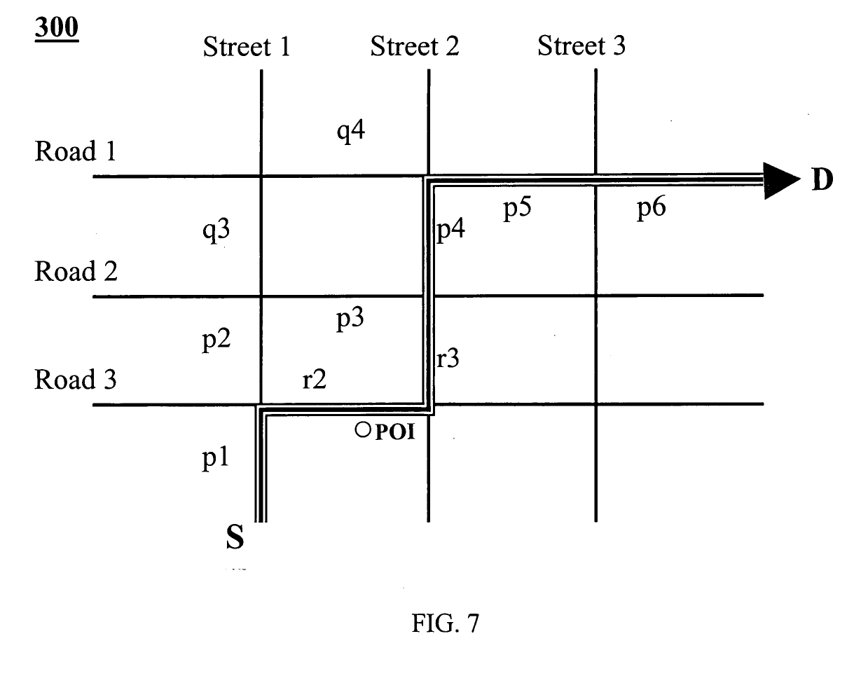

The navigation system allows an addition of road portion r2 by allowing or prompting the user to place a pointer PT at road portion r2 in the map to select road portion r2. For example, the navigation system allows or prompts the user to select road portion r2 in the map 300 by using a finger to touch the display at road portion r2. The navigation system, using its various components as discussed above in connection with FIG. 1, will detect the touch, identify the location of road portion r2, and determine yet another new route that includes road portion r2, as shown in FIG. 7.

FIG. 7 illustrates a sixth exemplary map display. The map display in FIG. 7 is similar to that in FIG. 6. However, in FIG. 7, route Rt6 is displayed in place of route Rt5. Although not shown in FIG. 7, route Rt6 may also be displayed in addition to route Rt5. Route Rt6 is the newest route that is determined to add road portion r2, based on the user's selection of road portion r2. As shown in FIG. 7, route Rt6 includes road portions p1, p5 and p6 that were included in route Rt5 in FIG. 6. However, route Rt6 includes road portions r2, r3 and p4 that were not included in Rt5, and excludes road portions p2, q3 and q4 that were included in Rt5.

Although only road portion r2 was intended to be added, Rt3 also adds road portions r3 and p4. This is because, when adding road portion r2, road portions r3 and p4, that are related to the addition of road portion r2, have to be simultaneously added to complete Rt6 between the starting point S and the destination D. Thus, the difference between Rt6 and Rt5 includes both the direct difference caused by the addition of road portion r2, and the related difference caused by the addition of road portions r3 and p4.

In FIG. 7, only road portions r2, r3 and p4 are added in Rt6. Rt6 is otherwise identical to Rt5. Although the degree of modification may appear large relative to the number of road portions displayed in FIG. 7, such a degree may actually be insignificant, because a route generally includes much more road portions. Thus, a new route will generally be substantially identical to an old route, and the degree of modification is generally limited.

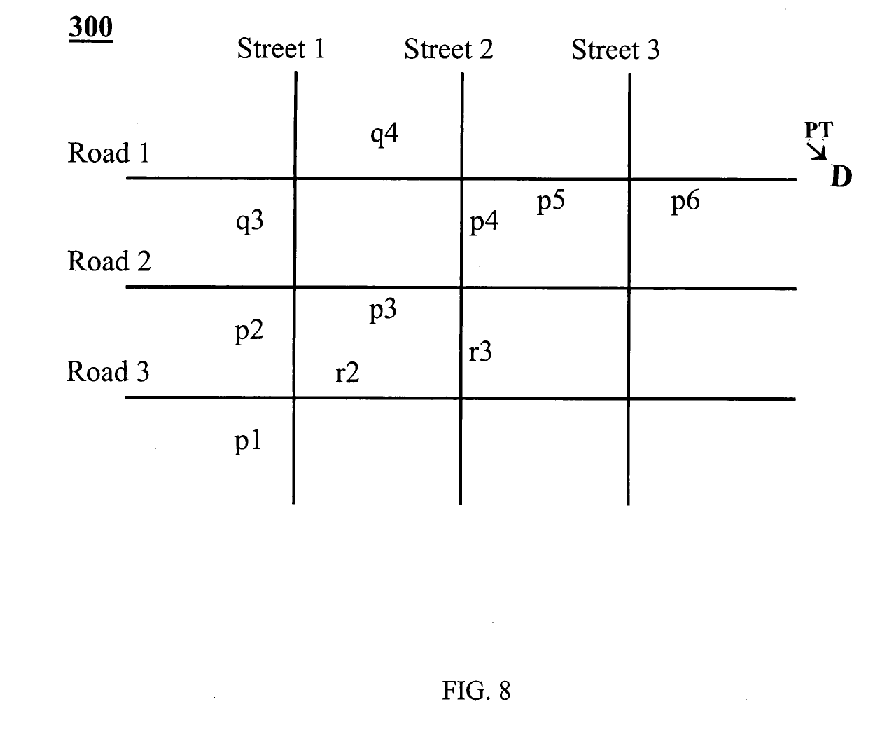

In various embodiments, the navigation system allows the user to create a fresh route from scratch, regardless of any previous routes, if any. In this aspect, the navigation system allows the user to complete the determination of the freshly new route based on a destination location provided by the user by placing a pointer at the destination location in the map. For example, the user may provide the destination by a first touch of the user's finger at a first location in the map. The route may be completed based on a starting point that may be subsequently provided by the location of the user detected by the GPS system 110 of FIG. 1. The starting point may also be provided by a second touch of the user's finger at a second location in the map, or by a street address of the starting point provided by the user. An example of such a determination is illustrated in FIG. 8.

FIG. 8 illustrates a seventh exemplary map display. The map display shown in FIG. 8 is similar to that shown in FIG. 5. In particular, as shown in FIG. 8, a portion of a geographic map 300 is displayed, and may include a plurality of roads, streets and road portions.

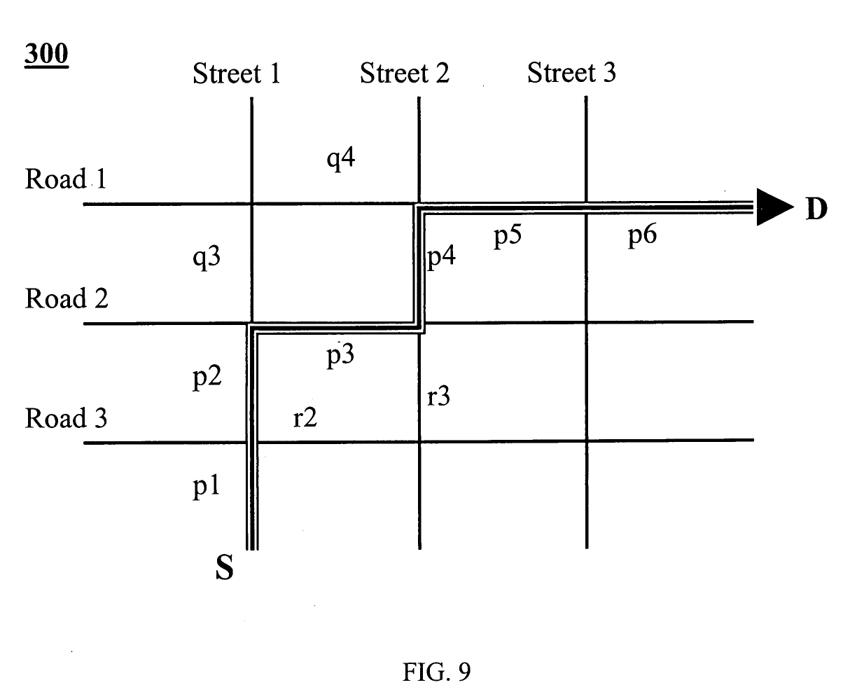

However, unlike FIG. 5, FIG. 8 does not have, or does not need, a pre-calculated route. Even if FIG. 8 may contain a pre-calculated route, the pre-calculated route will be irrelevant to completing the determination of the fresh route based on a destination location provided by the user by placing a pointer at the destination location in the map, as discussed below in connection with FIGS. 8 and 9.

Referring to FIG. 8, the user may wish to determine the fresh (freshly new) route to reach a destination location. However, the street address of the destination location may not be available to the user, although the user knows the whereabouts of the destination location on the map. Thus, the user may not be able to enter the street address of the destination location into the navigation system.

The navigation system allows or prompts the user to place a pointer PT at the destination location in the map to select the destination location. For example, the navigation system allows or prompts the user to select destination D near road portion p6 in the map 300 by using a finger to touch the display at destination D near road portion p6. The user may zoom-out the map display, so that the map display may cover a larger geographical area, to ensure that destination D is contained in the displayed map. The user may also zoom-in the map display to enhance the resolution of the map display to improve the accuracy of the selection. In addition, the user may shift (scrolling up/down, left/right, and combinations thereof) the map display to ensure that destination D is displayed in the map. The navigation system, using its various components as discussed above in connection with FIG. 1, will detect the touch, and identify the location of destination D. Once the location of destination D is identified, the navigation system allows the user to complete the freshly new route to destination D, as discussed in connection with FIG. 9.

FIG. 9 illustrates an eighth exemplary map display. The map display shown in FIG. 9 is similar to that shown in FIG. 8. However, in FIG. 9, a route R7 is completed that connects starting point S and destination D and includes road portions p1, p2, p3, p4, p5 and p6 therebetween.

In FIG. 9, the destination was provided as discussed above in connection with FIG. 8. The starting point S may be subsequently provided by the location of the user detected by the GPS system 110 of FIG. 1, by a second touch of the user's finger at a second location in the map, or by a street address of the starting point provided by the user. For example, when the user provides the starting point S by a second touch of the user's finger at a second location in the map, the navigation system, using its various components as discussed above in connection with FIG. 1, will detect the second touch, and identify the location of starting point S. Once the location of starting point S is identified, the navigation system provides Rt7 that connects the subsequently provided starting point S and the previously provided destination D.

In FIG. 9, route Rt7 may be modified to omit or add certain road portions, as discussed above in connection with FIGS. 2-7. Also, traffic data, if made available from the traffic database 120 of FIG. 1, may also be superimposed in the form of, for example, road conditions.

In various embodiments, the navigation system allows the user to complete the determination of a freshly new route from scratch based on a starting point provided by the user by placing a pointer at the starting point in the map. For example, the user may provide the starting point by a first touch of the user's finger at a first location in the map. The route may be completed based on a destination location that may be subsequently provided by a second touch of the user's finger at a second location in the map, or by a street address of the destination provided by the user. Such a process is a reversal of the process discussed above in connection with FIGS. 8 and 9, and will not be repeated here. However, it should be noted that the GPS system 110 of FIG. 1 may not be available to detect the location of the destination location when the GPS system is provided only for detecting the location where the user is.

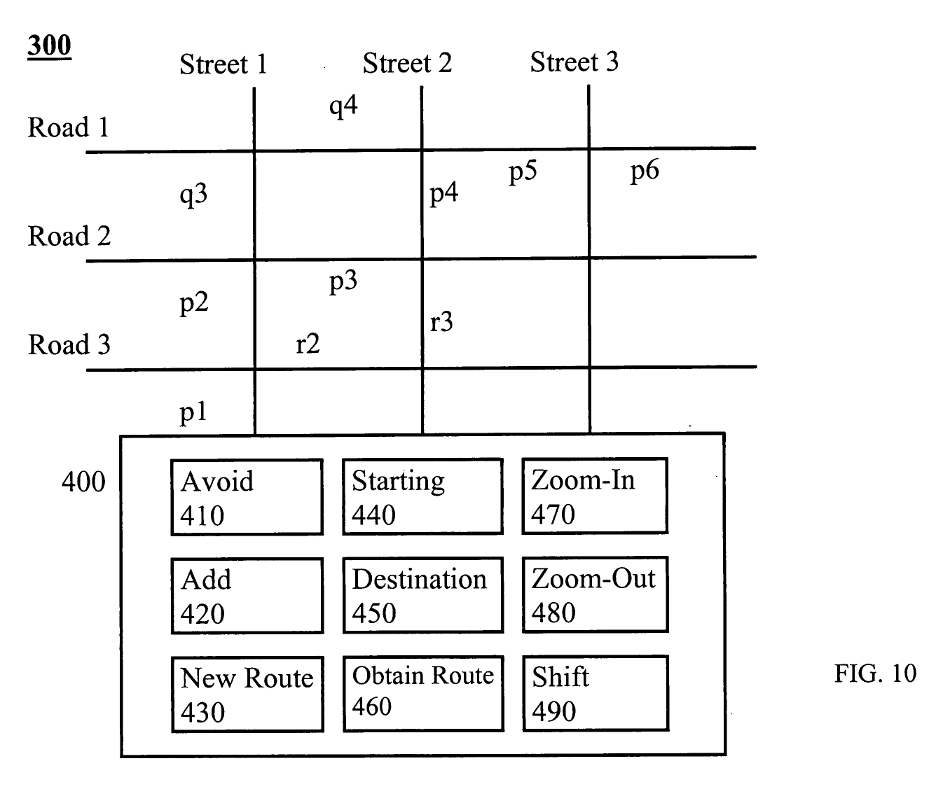

FIG. 10 illustrates a ninth exemplary map display. As shown in FIG. 10, the display of the navigation system may include panel 400 that provides options to a user. The options may include avoid 410 that allows the selection of a road portion to omit, add 420 that allows the selection of a road portion to be added, and a new route 430 that allows modification, based on a selected road portion to omit or add, of a pre-calculated route. The options may also include starting 440 that allows the selection of a starting point, a destination 450 that allows the selection of a destination location, and an obtain route 460 that allows determination of a route based on the selected starting point and/or destination location. In addition, the options may also include zoom-in 470, zoom-out 480, and shift 490 that allow manipulation of the map display for selecting a location or road portion.

As discussed above, a navigation system is provided that may include a display that displays a geographic map, the geographical map including a plurality of road portions; a display detector that prompts a pointer to be placed at one of the plurality of road portions in the display to select a specific road portion in the geographical map, and detects a geographical location of the selected road portion, wherein the display detector is connected to the display via wired or wireless connections; and a route finder that determines a route based on the geographical location of the selected road portion, the route connecting a starting geographical location and a destination geographical location via at least one of the plurality of road portions, wherein the route finder is connected to at least one of the display and the display detector via wired or wireless connections.

The navigation system may also include a display controller that displays at least one portion of the route on the display, the at least one portion of the route being superimposed on the geographical map. In the navigation system, the navigation system may allow the pointer to select the specific road portion by touching or pressing the display at the specific road portion in the geographical map.

In the navigation system, the geographical location of the selected road portion may be one of the destination geographical location and the starting geographical location. The other of the destination geographical location and the starting geographical location may be provided by a GPS system or a street address received from a user. Alternatively, the display detector may prompts the pointer to be placed at another one of the plurality of road portions to select another specific road portion in the geographical map, and detects another geographical location of the selected another road portion, such that the another geographical location of the selected another road portion may be the other of the destination geographical location and the starting geographical location.

In the navigation system, the determined route may be a new route that modifies an old route that was previously superimposed and displayed on the geographical map, the new route and the old route are substantially identical except for a difference related to the selected road portion, the difference including that the new route includes the selected road portion and the old route does not include the selected road portion.

In the navigation system, the determined route may be a new route that modifies an old route that was previously superimposed and displayed on the geographical map, the new route and the old route are substantially identical except for a difference related to the selected road portion, the difference including that the new route does not include the selected road portion and the old route includes the selected road portion.

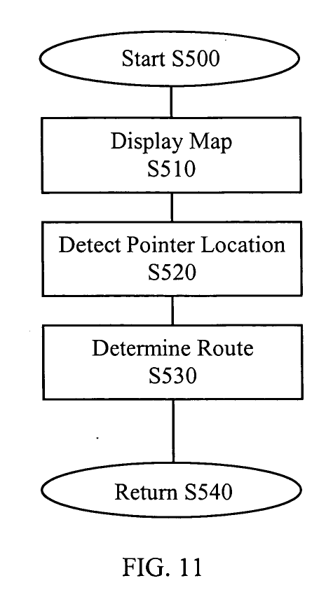

FIG. 11 illustrates an exemplary method for providing a route. As shown in FIG. 11, the method starts at step S500, where the method continues to step S510. Then, at step S 510, a map is displayed. The map may include a plurality of roads and road portions. The map may also include a pre-calculated route.

Next, at step S520, detection is made to identify the location of a pointer at a road portion in the map. Then, at step S530, a route is determined based on the detected location of the pointer. The route may be a new route that modifies the pre-calculated route by adding or omitting the road portion where the location of the pointer was detected. The route may also be a route that starts from, or ends at, the detected location. Thereafter, the method proceeds to step S 540, where the method returns.

As discussed above, a method is provided for providing a route on a navigation system. The method may include displaying a geographic map on a display, the geographical map including a plurality of road portions; prompting a pointer to be placed in the display at one of the plurality of road portions to select a specific road portion in the geographical map; detecting a geographical location of the selected road portion; and determining a route based on the geographical location of the selected road portion, the route connecting a starting geographical location and a destination geographical location via at least one of the plurality of road portions.

The method may also include displaying at least one portion of the route on the display, the at least one portion of the route being superimposed on the geographical map. The method may also include allowing the pointer to touch or press the display at the specific road portion in the geographical map to select the specific road portion.

In the method, the geographical location of the selected road portion may be one of the destination geographical location and the starting geographical location. The method may also include comprising receiving a street address from a user, or using a GPS system, to provide the other of the destination geographical location and the starting geographical location. The method may also include detecting, when a pointer is placed at another one of the plurality of road portions to select another specific road portion in the geographical map, another geographical location of the selected another road portion, so that the another geographical location of the selected another road portion is the other of the destination geographical location and the starting geographical location.

In the method, the determined route may be a new route that modifies an old route that was previously superimposed and displayed on the geographical map, the new route and the old route are substantially identical except for a difference related to the selected road portion, the difference including that the new route includes the selected road portion and the old route does not include the selected road portion.

In the method, the determined route may be a new route that modifies an old route that was previously superimposed and displayed on the geographical map, the new route and the old route are substantially identical except for a difference related to the selected road portion, the difference including that the new route does not include the selected road portion and the old route includes the selected road portion.

While various details have been described, these details should be viewed as illustrative, and not limiting. Various modifications, substitutes, improvements or the like may be implemented within the spirit and scope of the foregoing disclosure.

1. A navigation system, comprising:
a display that displays a geographic map, the geographical map including a plurality of road portions;
a display detector that prompts a pointer to be placed at one of the plurality of road portions in the display to select a specific road portion in the geographical map, and detects a geographical location of the selected road portion, wherein the display detector is connected to the display via wired or wireless connections; and
a route finder that determines a route based on the geographical location of the selected road portion, the route connecting a starting geographical location and a destination geographical location via at least one of the plurality of road portions, wherein the route finder is connected to at least one of the display and the display detector via wired or wireless connections.

2. The navigation system according to claim 1, further comprising a display controller that displays at least one portion of the route on the display, the at least one portion of the route being superimposed on the geographical map.

3. The navigation system according to claim 1, wherein the navigation system prompts the pointer to select the specific road portion by touching or pressing the display at the specific road portion in the geographical map.

4. The navigation system according to claim 1, wherein the geographical location of the selected road portion is one of the destination geographical location and the starting geographical location.

5. The navigation system according to claim 4, wherein the other of the destination geographical location and the starting geographical location is provided by a GPS system or a street address received from a user.

6. The navigation system according to claim 4, wherein:
the display detector prompts a pointer to be placed at another one of the plurality of road portions to select another specific road portion in the geographical map, and detects another geographical location of the selected another road portion; and
the another geographical location of the selected another road portion is the other of the destination geographical location and the starting geographical location.

7. The navigation system according to claim 1, wherein the determined route is a new route that modifies an old route that was previously superimposed and displayed on the geographical map, the new route and the old route are substantially identical except for a difference related to the selected road portion, the difference including that the new route includes the selected road portion and the old route does not include the selected road portion.

8. The navigation system according to claim 1, wherein the determined route is a new route that modifies an old route that was previously superimposed and displayed on the geographical map, the new route and the old route are substantially identical except for a difference related to the selected road portion, the difference including that the new route does not include the selected road portion and the old route includes the selected road portion.

9. A vehicle comprising the navigation system according to claim 1.

10. A computerized device comprising the navigation system according to claim 1.

11. A method for providing a route on a navigation system, comprising:
displaying a geographic map on a display, the geographical map including a plurality of road portions;
prompting a pointer to be placed in the display at one of the plurality of road portions to select a specific road portion in the geographical map;
detecting a geographical location of the selected road portion; and
determining a route based on the geographical location of the selected road portion, the route connecting a starting geographical location and a destination geographical location via at least one of the plurality of road portions.

12. The method according to claim 11, further comprising displaying at least one portion of the route on the display, the at least one portion of the route being superimposed on the geographical map.

13. The method according to claim 11, further comprising prompting the pointer to touch or press the display at the specific road portion in the geographical map to select the specific road portion.

14. The method according to claim 11, wherein the geographical location of the selected road portion is one of the destination geographical location and the starting geographical location.

15. The method according to claim 14, further comprising receiving a street address from a user, or using a GPS system, to provide the other of the destination geographical location and the starting geographical location.

16. The method according to claim 14, further comprising:
prompting a pointer to be placed at another one of the plurality of road portions to select another specific road portion in the geographical map, and detecting another geographical location of the selected another road portion,
wherein the another geographical location of the selected another road portion is the other of the destination geographical location and the starting geographical location.

17. The method according to claim 11, wherein the determined route is a new route that modifies an old route that was previously superimposed and displayed on the geographical map, the new route and the old route are substantially identical except for a difference related to the selected road portion, the difference including that the new route includes the selected road portion and the old route does not include the selected road portion.

18. The method according to claim 11, wherein the determined route is a new route that modifies an old route that was previously superimposed and displayed on the geographical map, the new route and the old route are substantially identical except for a difference related to the selected road portion, the difference including that the new route does not include the selected road portion and the old route includes the selected road portion.

19. A navigation system, comprising:
means for displaying a geographic map, the geographical map including a plurality of road portions;
means for prompting a pointer to be placed at one of the plurality of road portions to select a specific road portion in the geographical map displayed on the means for displaying, and for detecting a geographical location of the selected road portion, wherein the means for detecting is connected to the means for displaying via wired or wireless connections; and
means for determining a route based on the geographical location of the selected road portion, the route connecting a starting geographical location and a destination geographical location via at least one of the plurality of road portion, wherein the means for determining is connected to at least one of the means for displaying and the means for detecting via wired or wireless connections,
wherein the means for displaying displays at least one portion of the route, the at least one portion of the route being superimposed on the geographical map,
wherein the navigation system prompts the pointer to select the specific road portion by touching or pressing the means for displaying at the specific road portion on the geographical map; and
wherein the determined route is a new route that modifies an old route that was previously superimposed and displayed on the geographical map, the new route and the old route are substantially identical except for a difference related to the selected road portion, the difference including that the new route includes or excludes the selected road portion and the old route excludes or includes, respectively, the selected road portion.

20. The navigation system according to claim 19, wherein the difference related to the selected road portion includes that the new route excludes the selected road portion and the old route includes the selected road portion.

21. A computer-readable product capable of providing computer-executable instructions for performing the method recited in claim 11.
